(19) United States
(12) Patent Application Publication
(10) Pub. No.: US 2012/0238397 A1
(43) Pub. Date: Sep. 20, 2012

(54) LIMITED SLIPPERY DIFFERENTIAL FOR REMOTE CONTROL MODEL VEHICLE

(75) Inventor: Chun-Min YEH, Taichung City (TW)

(73) Assignee: TOPWAY MODEL RESEARCH CO., LTD., Taichung City (TW)

(21) Appl. No.: 13/153,774

(22) Filed: Jun. 6, 2011

(30) Foreign Application Priority Data
Mar. 15, 2011 (TW) 100108815
Apr. 29, 2011 (TW) 100115233

(51) Int. Cl. F16H 48/20

(52) U.S. Cl. 475/233

(57) ABSTRACT

A limited slippery differential used in a remote control model vehicle is disclosed to include a housing, a main gear mounted on one side of the housing, two transmission gears mounted inside the housing, and a differential unit mounted in the housing. When the remote control model vehicle is moving over a turn at a high speed, bevel gears of the differential unit are forced into positive engagement with respective transmission gears to reduce the speed of the vehicle wheels that are suspending in the air. When the remote control model vehicle moved over the turn, the bevel gears are forced away from the transmission gears by respective spring members, enabling engine power to be normally transferred to the wheels.

### BACKGROUND OF THE INVENTION

1. Field of the Invention

The present invention relates to model vehicles and more particularly, to a limited slippery differential for remote control model vehicle.

2. Description of the Related Art

Taiwan Patent Publication No. M336058 discloses a differential design, entitled “Differential for Model Vehicle”. This design uses a cross-shaped shaft to move sliding blocks in respective positioning grooves in a housing when the model vehicle is moving over a turn at a high speed, avoiding impact damage and enabling respective first bevel gears to be moved into engagement with respective second bevel gears to reduce the speed of output shafts and to avoid power loss due to idle running of the wheels that are suspending in the air.

When the model vehicle moved over the turn, the first bevel gears must be disengaged from the respective second bevel gears so that the second bevel gears can return to normal running However, in the aforesaid design, the centrifugal force is insufficient to move the respective first bevel gears completely away from the respective second bevel gears after the model vehicle moved over the turn. Under this condition, one or a number of the first bevel gears may be still kept in mesh with the respective second bevel gears during rotation of the second bevel gears, thus, the engine power cannot effectively transferred to the wheels, causing power loss.

### SUMMARY OF THE INVENTION

The present invention has been accomplished under the circumstances in view. It is the main object of the present invention to provide a limited slippery differential for remote model vehicle, which effectively reduces power loss.

To achieve this and other objects of the present invention, a limited slippery differential is used in a remote control model vehicle, comprising a housing, a main gear, a first output unit and a second output unit and a differential unit. The housing defines therein an accommodation chamber and four grooves. The grooves are inwardly curved in the peripheral wall of the accommodation chamber in a crossed manner. The main gear is fixedly mounted on one side of the housing. The first output unit and the second output unit each comprise a transmission gear and an output shaft. The transmission gears of the first and second output units are mounted in the accommodation chamber at two opposite sides. The output shaft of the first output unit is inserted through the main gear and connected to the transmission gear of the first output unit. The output shaft of the second output unit is inserted through an opposite side of the housing remote from the main gear and connected to the transmission gear of the second output unit. The differential unit is mounted in the accommodation chamber of the housing, comprising a cross shaft, four sliding blocks, four bevel gears and four spring members. The cross shaft is set between the transmission gears of the first and second output units. The sliding blocks is respectively sleeved onto the ends of the cross shaft and movable back and forth in the grooves of the housing. The bevel gears are respectively slidably mounted on the cross shaft and engageable with the transmission gears of the first and second output units. The spring members are respectively sleeved onto the cross shaft, having respective two opposite ends respectively stopped against the center of the cross shaft and the bevel gears.

Thus, when the remote control model vehicle is moving over a turn at a high speed, bevel gears of the differential unit are forced into positive engagement with respective transmission gears to reduce the speed of the vehicle wheels that are suspending in the air; when the remote control model vehicle moved over the turn, the bevel gears are forced away from the transmission gears by respective spring members, enabling engine power to be normally transferred to the wheels.

### BRIEF DESCRIPTION OF THE DRAWINGS

FIG. 1 is a cutaway of a limited slippery differential for remote control model vehicle in accordance with a first embodiment of the present invention.

FIG. 2 is an exploded view of the limited slippery differential for remote control model vehicle in accordance with the first embodiment of the present invention.

FIG. 3 is a longitudinal sectional view of the limited slippery differential for remote control model vehicle in accordance with the first embodiment of the present invention.

FIG. 4 is a transverse sectional view of the first embodiment of the present invention, illustrating the bevel gears disengaged from the respective transmission gears.

FIG. 5 is similar to FIG. 4, illustrating the bevel gears meshed with the respective transmission gears.

FIG. 6 is a transverse sectional view of limited slippery differential for remote control model vehicle in accordance with a first embodiment of the present invention, illustrating bevel gears disengaged from respective transmission gears.

FIG. 7 is similar to FIG. 6, illustrating the bevel gears meshed with the respective transmission gears.

### DETAILED DESCRIPTION OF THE INVENTION

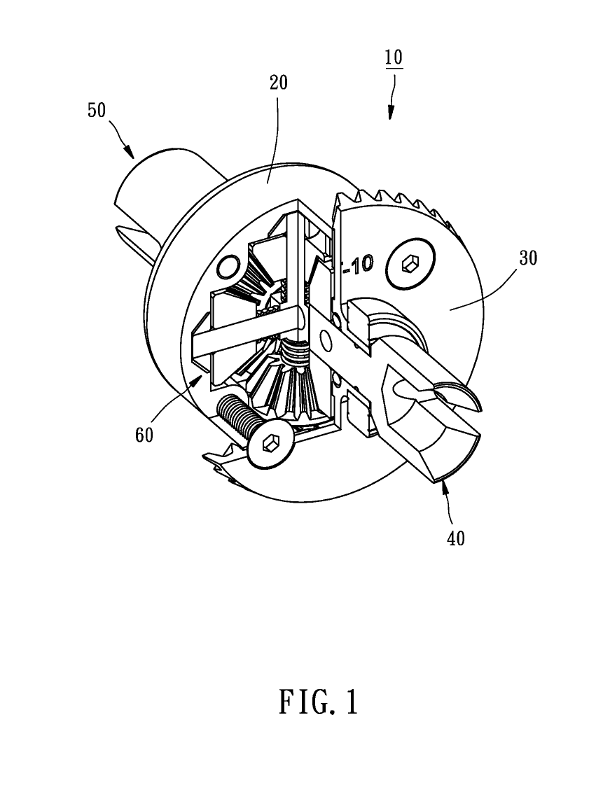

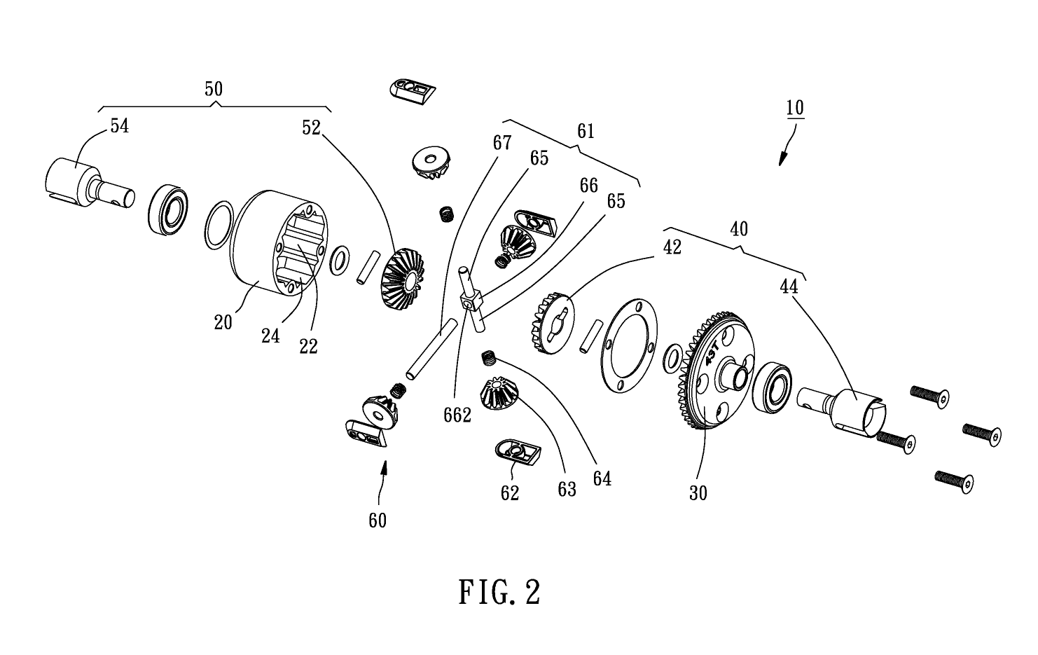

Referring to FIGS. 1 and 2, a limited slippery differential 10 for remote control model vehicle in accordance with the present invention is shown comprising a housing 20, a main gear 30, a first output unit 40, a second output unit 50 and a differential unit 60.

The housing 20 defines therein an accommodation chamber 22 and four grooves 24. The grooves 24 are inwardly curved in the peripheral wall of the accommodation chamber 22 in a crossed manner, having a trapezoidal cross section. The distance between one relatively narrower side of each groove 24 and the center of the housing 20 is smaller than the distance between the relative greater opposite side of the respective groove 24 and the center of the housing 20. Further, each groove 24 has one arched end.

The main gear 30 is mounted on one side of the housing 20 and can be driven by the engine power of a model vehicle to rotate the housing 20.

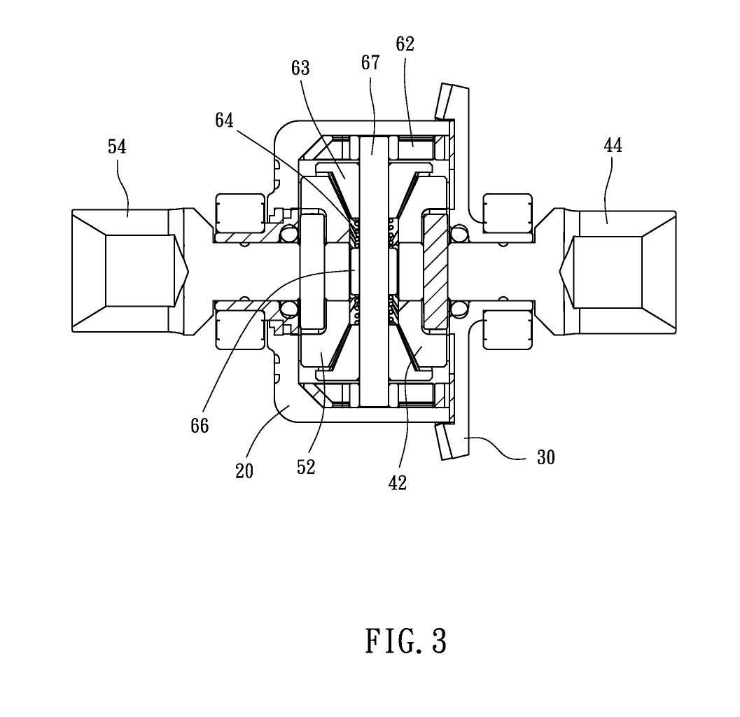

Referring to FIG. 3 and FIG. 2 again, the first and second output units 40;50 each comprise a transmission gear 42;52 and an output shaft 44;54. The transmission gears 42;53 are mounted in the accommodation chamber 22 at two opposite sides. The output shaft 44 of the first output unit 40 is inserted through the main gear 30 and connected to the transmission gear 42. The output shaft 54 of the second output unit 50 is inserted through an opposite side of the housing 20 remote from the main gear 30 and connected to the associating transmission gear 52. Thus, the output units 40;50 are synchronously rotated to transmit power to respective vehicle wheels when the main gear 30 is rotating the housing 20.

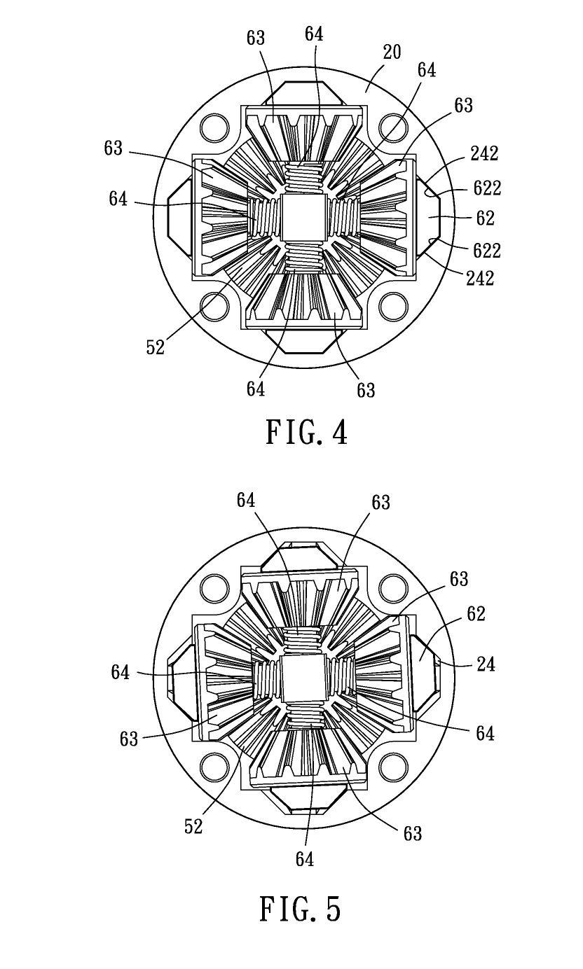

The differential unit 60 is mounted in the accommodation chamber 22 of the housing 20, comprising a cross shaft 61, four sliding blocks 62, four bevel gears 63 and four spring members 64. The cross shaft 61 is set between the transmission gears 42;52 of the output units 40;50, comprising two short axles 65, a rectangular block 66 and one long axle 67. The rectangular block 66 is connected between the two short axles 65, having a round hole 662 for the insertion of the long axle 67. The sliding blocks 62 are respectively sleeved onto one end of each of the short axles 65 and each end of the long axle 67, each having two second slopes 622 fitting the grooves 24 of the housing 20 so that each sliding block 62 can be moved back and forth along one respective groove 24 of the housing 20 and abutted with the second slopes 522 against respective first slopes 242 in the grooves 24, as shown in FIG. 4. The bevel gears 63 are respectively slidably mounted on the short axles 65 and the long axle 67 and engageable with the transmission gears 42;52. The spring members 64 have the respective two opposite ends respectively stopped against the rectangular block 66 and the bevel gears 63 to impart a return pressure.

Thus, when the engine power is transferred to the main gear 30, the main gear 30 and the housing 20 are synchronously rotated. At this time, a part of the engine power is transferred to the first output shaft 44 and the other part of the engine power is transferred to the second output shaft 54, and therefore the engine power is transferred to the vehicle wheels of the remote control model vehicle through the first output shaft 44 and the second output shaft 54 to move the remote control model vehicle.

When the remote control model vehicle is moving over a turn in a track at a high speed, the vehicle wheels at the inner side of the track are lifted into the air due to the effect of centrifugal force. At this time, the cross shaft 61 is biased. During biasing of the cross shaft 61, the sliding blocks 62 are moved in the respective grooves 24, avoiding impact and forcing the bevel gears 63 to move toward the center of the cross shaft 61 into mesh with the respective transmission gears 42;52 and to further compress the respective spring members 64, as shown in FIG. 5. Thus, the revolving speed of the transmission gears 42;52 is relatively reduced, avoiding power loss due to idle running of the vehicle wheels that are suspending in the air.

After moved over the turn, the respective bevel gears 63 are moved away from the respective transmission gears 42;52 by the respective spring members 64, as shown in FIG. 4, enabling the first and second output units 40;50 to return to normal running and to further transfer the engine power to the respective vehicle wheels.

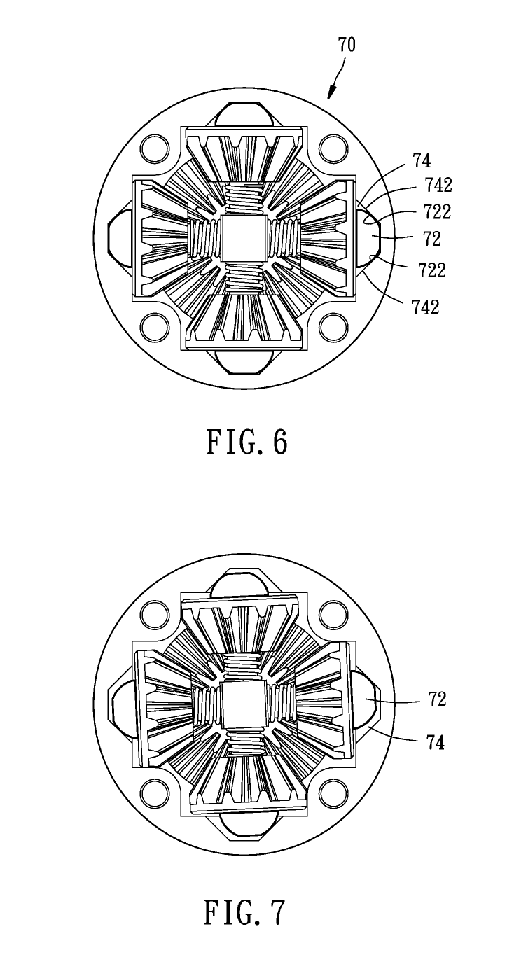

FIGS. 6 and 7 illustrate a limited slippery differential 70 for remote control model vehicle in accordance with a second embodiment of the present invention. This second embodiment is substantially similar to the aforesaid first embodiment with the exception that each sliding block 72 has two arched faces 722 respectively abutted against respective slopes 752 in the grooves 74, as shown in FIG. 6, facilitating smooth movement of the respective sliding blocks 72 in the respective grooves 74 when the remote control model vehicle is moving over a turn in a track at a high speed, as shown in FIG. 7, and therefore the limited slippery differential 70 achieves high performance.

In conclusion, the limited slippery differential of the present invention utilizes the design of the sliding blocks to keep the bevel gears of the differential unit in positive engagement with the transmission gears of the first and second output units when the remote control model vehicle is moving over a turn, and also utilizes the design of the spring members to let the bevel gears of the differential unit be accurately disengaged from the transmission gears of the first and second output units after the remote control model vehicle moved over the turn, and therefore power loss is minimized

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A limited slippery differential used in a remote control model vehicle, comprising:
a housing defining therein an accommodation chamber and four grooves, said grooves being inwardly curved in the peripheral wall of said accommodation chamber in a crossed manner;
a main gear fixedly mounted on one side of said housing;
a first output unit and a second output unit, said first output unit and said second output unit each comprising a transmission gear and an output shaft, the transmission gears of said first output unit and said second output unit being mounted in said accommodation chamber at two opposite sides, the output shaft of said first output unit being inserted through said main gear and connected to the transmission gear of said first output unit, the output shaft of said second output unit being inserted through an opposite side of said housing remote from said main gear and connected to the transmission gear of said second output unit; and
a differential unit mounted in said accommodation chamber of said housing, said differential unit comprising a cross shaft, four sliding blocks, four bevel gears and four spring members, said cross shaft being set between the transmission gears of said first output unit and said second output unit, said sliding blocks being respectively sleeved onto the ends of said cross shaft and movable back and forth in said grooves of said housing, said bevel gears being respectively slidably mounted on said cross shaft and engageable with the transmission gears of said first output unit and said second output unit, said spring members being respectively sleeved onto said cross shaft and having respective two opposite ends respectively stopped against the center of said cross shaft and said bevel gears.

2. The limited slippery differentia as claimed in claim 1, wherein said cross shaft comprises two short axles, a rectangular block and one long axle, said rectangular block being connected between said two short axles and defining therein a round hole, said long axle being inserted through the round hole of said rectangular block; said sliding blocks are respectively sleeved on one end of each of said short axles and each end of said long axle; said bevel gears are respectively slidably mounted on said short axles and said long axle; said spring members have the respective two opposite ends respectively stopped against said rectangular block and said bevel gears.

3. The limited slippery differentia as claimed in claim 1, wherein said grooves of said housing have a trapezoidal cross section, each said groove comprising two first slopes, the distance between one relatively narrower side of each said groove and the center of said housing being smaller than the distance between a relative greater opposite side of the respective groove and the center of said housing; said sliding blocks are configured to fit the trapezoidal cross section of said grooves, each said sliding block comprising two second slopes respectively abutted against the first slopes of the associating groove.

4. The limited slippery differentia as claimed in claim 3, wherein each said groove of said housing has one arched end.

5. The limited slippery differentia as claimed in claim 1, wherein said grooves of said housing have a trapezoidal cross section, each said groove comprising two slopes, the distance between one relatively narrower side of each said groove and the center of said housing being smaller than the distance between a relative greater opposite side of the respective groove and the center of said housing; said sliding blocks are configured to fit the trapezoidal cross section of said grooves, each said sliding block comprising two arched faces respectively abutted against the slopes of the associating groove.

6. The limited slippery differentia as claimed in claim 6, wherein each said groove of said housing has one arched end; each said sliding block has one arched end.
